(19) United States
(12) Patent Application Publication
(10) Pub. No.: US 2025/0151702 A1
(43) Pub. Date: May 15, 2025

(54) PET TOY

(71) Applicant: Doskocil Manufacturing Company, Inc., Arlington, TX (US)

(72) Inventors: Jill Jackson, Fort Worth, TX (US); Ron Bagley, Dallas, TX (US); Sunil Pinto, Arlington, TX (US); Josiah Wilhelm, Fort Worth, TX (US)

(73) Assignee: Doskocil Manufacturing Company, Inc., Arlington, TX (US)

(21) Appl. No.: 19/026,068

(22) Filed: Jan. 16, 2025

Related U.S. Application Data
(63) Continuation of application No. 17/391,351, filed on Aug. 2, 2021, now Pat. No. 12,245,569.
(60) Provisional application No. 63/107,578, filed on Oct. 30, 2020.

(51) Int. Cl. A01K 15/02

(52) U.S. Cl. CPC A01K 15/025

(57) ABSTRACT

A pet toy includes a curved body portion, a noise making device, and a bottom portion coupled to the curved body portion. The curved body portion has a substantially hollow interior. The bottom portion has a substantially planar lower surface, an upper surface, and a wall extending from the upper surface. The noise making device is coupled to the upper surface and has a lower portion and an upper portion. The bottom portion is coupled to the curved body portion so that the wall is received within the substantially hollow interior of the curved body portion. The curved body portion is adapted to be compressed relative to at least a portion of the noise making device and the wall of the bottom portion. The noise making device is configured to emit a noise when sufficiently compressed between the curved body portion and the wall.

### CROSS-REFERENCE TO RELATED PATENT APPLICATIONS

This application is a continuation of U.S. patent application Ser. No. 17/391,351, filed Aug. 2, 2021, which claims priority to U.S. Provisional Patent Application No. 63/107,578, filed Oct. 30, 2020, both of which are incorporated herein by reference in their entireties.

### BACKGROUND

The present invention relates to a pet toy. In particular, the present invention relates to a pet toy that has a body portion and a sliding portion configured to increase indoor pet enjoyment.

Many pets spend considerable time in doors with or without owners present. Therefore, many pet owners attempt to occupy their pets using toys. Some conventional pet toys attempt to increase pet enjoyment and occupation of a pet's attention by providing an internal noise making device. Further, many owners attempt to occupy a pet's attention by playing with pet toys; however, most conventional pet toys require human interaction for a pet to enjoy the toy.

### SUMMARY OF THE INVENTION

It has been found that in certain circumstances some owners do not have sufficient time to spend with their pets. Therefore, in these circumstances many pets are not provided with sufficient exercise and can grow bored through the day. Accordingly, an improved pet toy that is capable of occupying a pet without the need for human (or owner) interaction is desired. The embodiments of the pet toy described herein are an improved pet toy that can provide a pet with sufficient exercise and can occupy a pet's attention for an extended period of time.

In one embodiment, pet toy includes a curved body portion, a bottom portion, and a noise making device. The curved body portion has a substantially hollow interior. The bottom portion is coupled to the curved body portion. The bottom portion has a substantially planar lower surface, an upper surface substantially opposite the lower surface, and a wall extending from the upper surface. The noise making device is coupled to the upper surface. The noise making device has a lower portion and an upper portion. The lower portion is coupled to the upper portion. The bottom portion is coupled to the curved body portion so that the wall is received within the substantially hollow interior of the curved body portion. The curved body portion is adapted to be compressed relative to at least a portion of the noise making device and the wall of the bottom portion. The noise making device is configured to emit a noise when sufficiently compressed between the curved body portion and the wall.

In another embodiment, a pet toy includes a curved body portion, a bottom portion, and an air-operated noise making device. The curved body portion has a substantially hollow interior and an opening provided therein. The bottom portion is coupled to the curved body portion. The bottom portion has a substantially planar lower surface, an upper surface substantially opposite the lower surface, and an air-operated noise making device coupled to the upper surface. The noise making device has a lower portion and an upper portion. The lower portion is coupled to the upper portion. The noise making device is coupled to the bottom portion so that the noise making device is received in the substantially hollow interior. The noise making device is adapted to be compressed and configured to emit a noise toward the opening when sufficiently compressed.

In yet another embodiment, a method of producing a pet toy includes providing a curved body portion having a substantially hollow interior and providing a bottom portion. The bottom portion has a lower surface, an upper surface substantially opposite the lower surface, and a wall extending from the upper surface. The method of producing the pet toy includes inserting a noise making device into the wall of the bottom portion. The noise making device includes a lower portion and an upper portion. The lower portion is coupled to the upper portion. The method of producing the pet toy includes coupling the bottom portion to the curved body portion such that the lower portion of the noise making device is positioned within the substantially hollow interior.

In view of the state of the known technology, a first aspect of the present disclosure provides a pet toy comprising a body portion and a sliding portion. The body portion has a curved top portion with an arcuate side portion. The sliding portion is attached to a bottom surface of the body portion, and is formed from rigid plastic so as to have a reduced coefficient of friction relative to a surface on which the pet toy is to slide.

In a second aspect of the disclosure according to the first aspect, the arcuate side portion is a first arcuate side portion, and the body portion includes a second arcuate side portion.

In a third aspect of the disclosure according to the first aspect or second aspect, the second arcuate side portion is disposed opposite the first arcuate side portion.

In a fourth aspect of the disclosure according to any of the preceding aspects, the body portion includes a noise making device.

In a fifth aspect of the disclosure according to any of the preceding aspects, the body portion is hollow.

In a sixth aspect of the disclosure according to any of the preceding aspects, the body portion is formed from a flexible material.

In a seventh aspect of the disclosure according to any of the preceding aspects, the sliding portion includes a support member on an upper surface thereof

In an eighth aspect of the disclosure according to any of the preceding aspects, the rigid plastic is polypropylene.

A ninth aspect of the disclosure is directed to method of producing a pet toy. The method comprises forming a body portion having bottom portion and a curved top portion, the curved top portion including an arcuate side portion, forming a sliding portion from rigid plastic so as to have a reduced coefficient of friction relative to a surface on which the pet toy is to slide, and attaching the sliding portion to the body portion.

In a tenth aspect of the disclosure according to any of the preceding aspects, the arcuate side portion is a first arcuate side portion, and the forming the body portion includes forming a second arcuate side portion.

In an eleventh aspect of the disclosure according to any of the preceding aspects, the forming the second arcuate side portion includes forming the second arcuate side portion opposite the first arcuate side portion.

In a twelfth aspect of the disclosure according to any of the preceding aspects, a noise making device is inserted into the body portion.

In a thirteenth aspect of the disclosure according to any of the preceding aspects, the forming the body portion includes forming the body portion to have a hollow interior.

In a fourteenth aspect of the disclosure according to any of the preceding aspects, the forming the body portion includes forming the body portion from a flexible material.

In a fifteenth aspect of the disclosure according to any of the preceding aspects, the forming the sliding portion includes forming the sliding portion with a support member on an upper surface thereof

In a sixteenth aspect of the disclosure according to any of the preceding aspects, the forming the sliding portion includes forming the sliding portion from polypropylene.

The pet toy according to the embodiments of the present disclosure provide an improved pet toy that is capable of occupying a pet indoors for extended periods of time. The configuration and materials of the body portion (i.e., the curved top portion with the arcuate side portions) causes the pet toy to shoot out at unexpected or unpredictable angles and directions when stepped on (e.g., by a paw of the pet). The sliding portion is configured to have a low or reduced coefficient of friction relative to many indoor surfaces (such as carpet, tile, wood, etc.), enabling the pet toy to race or shoot and slide across the indoor surface. This sudden unpredictable movement causes the pet's “animal instinct” to be activated or triggered and the pet will chase the toy. Further, the pet toy can have a noise making device—i.e., a “squeaker” or squeaking device—that is activated when the pet toy is stepped on. The noise from the noise making device will further engage the pet. Further, since the pet toy is formed from rubber it can be resistant to pet chewing, prolonging the life of the toy.

As can be understood, the pet toy described herein will increase the occupation of a pet's attention, while also improving the pets exercise, since the pet will chase the pet toy through an indoor area of a home or house or other indoor structure. Further, the pet toy will improve the occupation of a pet's attention without the need for additional food or treats. Thus, as can be understood, the pet toy as described herein will improve a pet's health, by increasing the pet's activity and reduce the pet's boredom by increasing the pet's attention to the toy without the need to human interaction and additional food. Accordingly, pets using the pet toy described will be healthier and happy and owners can be happier.

### BRIEF DESCRIPTION OF THE DRAWINGS

The invention will be explained in more detail hereinafter with reference to the drawings.

FIG. 1 is a top perspective view of a pet toy according to one embodiment of the present invention;

FIG. 2 is bottom perspective view of the pet toy according to FIG. 1;

FIG. 3 is a top plan view of the pet toy according to FIG. 1;

FIG. 4 is a bottom view of the pet toy according to FIG. 1;

FIG. 5 is a side view of the pet toy according to FIG. 1;

FIG. 6 is a front view of the pet toy according to FIG. 1;

FIG. 7 is sectional view of the pet toy according to FIG. 1; and

FIG. 8 is top perspective view of the sliding portion of the pet toy according to FIG. 1.

### DETAILED DESCRIPTION

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

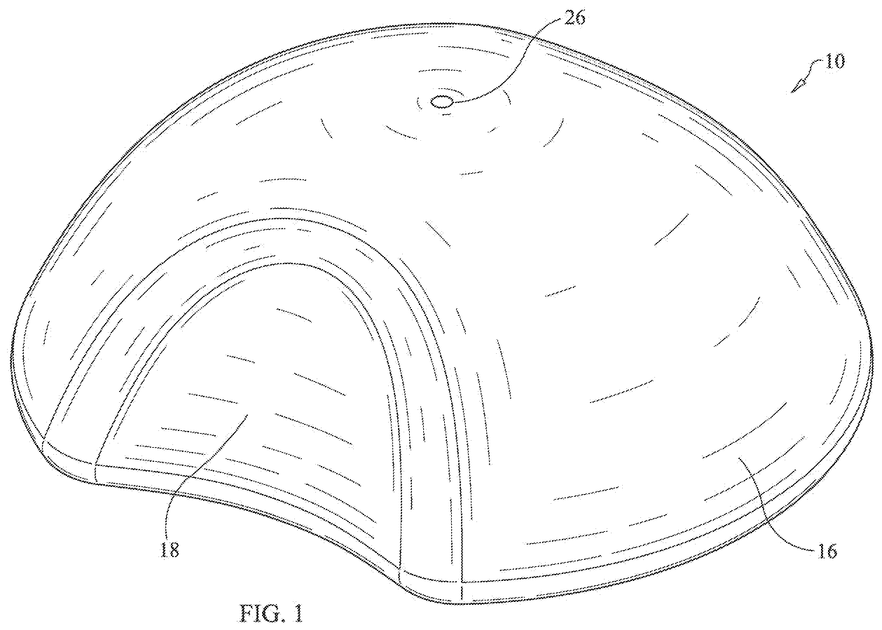

Referring initially to FIGS. 1-3, a pet toy 10 is illustrated in accordance with a first embodiment. The pet toy 10 includes a body portion 12 and a sliding portion 14. As can be understood, the pet toy 10 is configured to occupy a pet indoors by sliding on a surface along the sliding portion 14. The body portion 12 is configured such that when the pet contacts the pet toy 10 the toy can move erratically due the configuration or can be propelled due to the combination of materials and the shape of the body portion 12. In other words, when a pet attempts to put vertical pressure on the body portion 12, since the body portion 12 has an arcuate configuration and the body portion 12 is formed form a semi rigid, elastic material, the body portion 12 will be propelled from under the pet's paw and move along a surface.

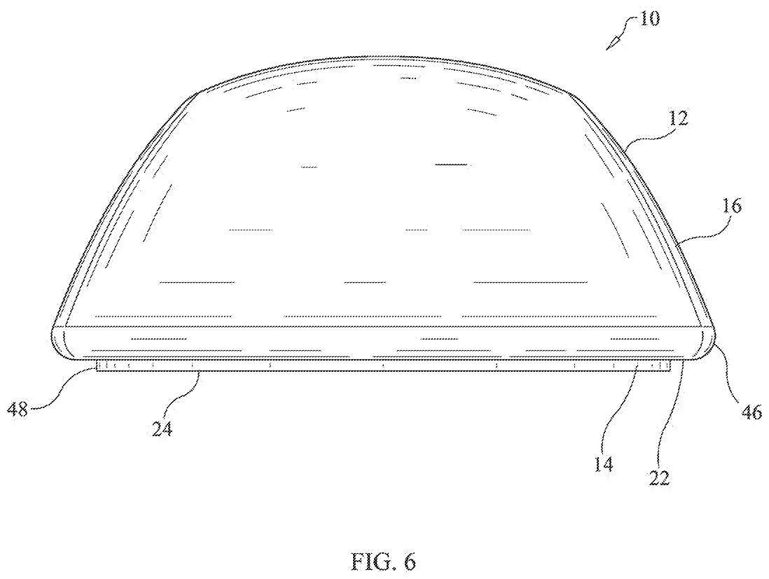

As can be seen in FIGS. 1, 5 and 6, the body portion 12 has a curved top portion 16 with a domed configuration. The curved top portion 16 can have first and second inwardly extending arcuate or concaved side portions 18 and 20. That is, the body portion 12 is generally semi-spherical with a rounded or curved top portion and 16 a flat bottom portion 22. In some embodiments, the body portion 12 can be made from rubber or any other suitable flexible material or semi rigid. That is, the body portion 12 can be configured to having sufficient flexible such that when sufficient force is applied in a direction transverse to the surface on which the pet toy 10 is disposed, the body portion 12 can be slightly deformed or depressed. However, it is noted that the body portion 12 can be sufficiently rigid, such that the force on the rounded body portion 12 causes the toy to “shoot” out from underneath of the object (e.g., paw) that is pressing on the surface. This “shooting” out of the pet toy 10 is helped by the low or reduced coefficient of friction between the pet toy 10 and the bottom surface 24 of the sliding portion 14.

The body portion 12 can have an opening or hole 26 in the curved top portion 16 that enables a squeaking sound to be emitted therefrom. In one embodiment, the hole 26 is in the apex of the curved top portion 16; however, it is noted that the hole 26 can be in any suitable position on the pet toy 10. As can be understood, a noise making device 28 (squeaking device) or other device can be disposed in (or adjacent) the hole 26, such that when the body portion 12 is deformed from pressure being applied thereto, air is expelled out of the noise making device 28 and out of the squeaker hole 26 causing a noise.

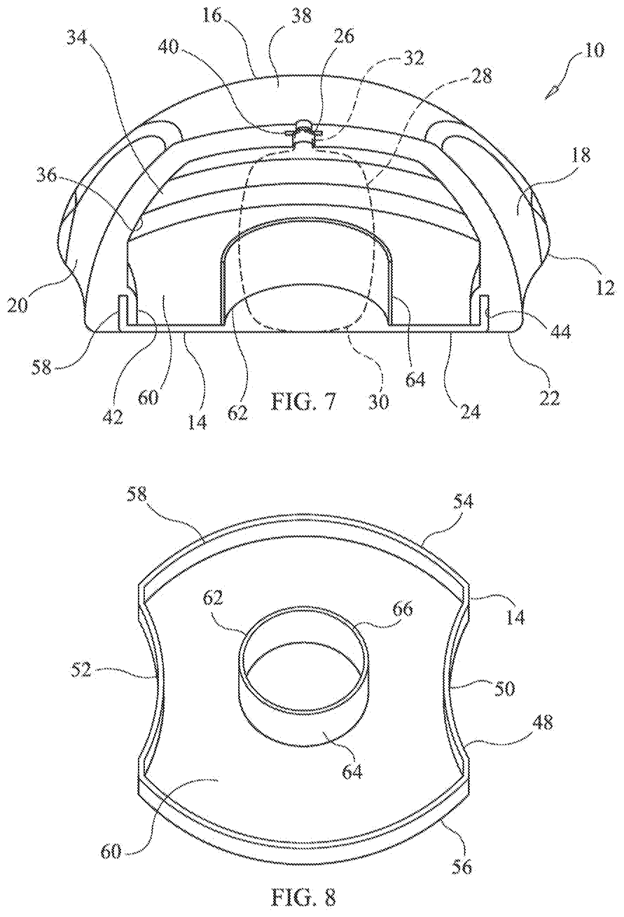

The noise making device 28 can be any suitable device. As shown in FIG. 7, in one embodiment, the noise making device is a flexible, plastic bulb 30 with air disposed in the interior thereof. The noise making device 28 also includes a neck portion or protrusion 32 connected to the bulb 30 that is disposed within the opening 26. The noise making device is configured such that, when compressed the air in the interior of the bulb 30 is expelled through the neck portion 32 causing a whistling or squeaking noise. However, it is noted that the noise making device 28 can be any suitable device that makes the appropriate or desired noise for use with the pet toy 10.

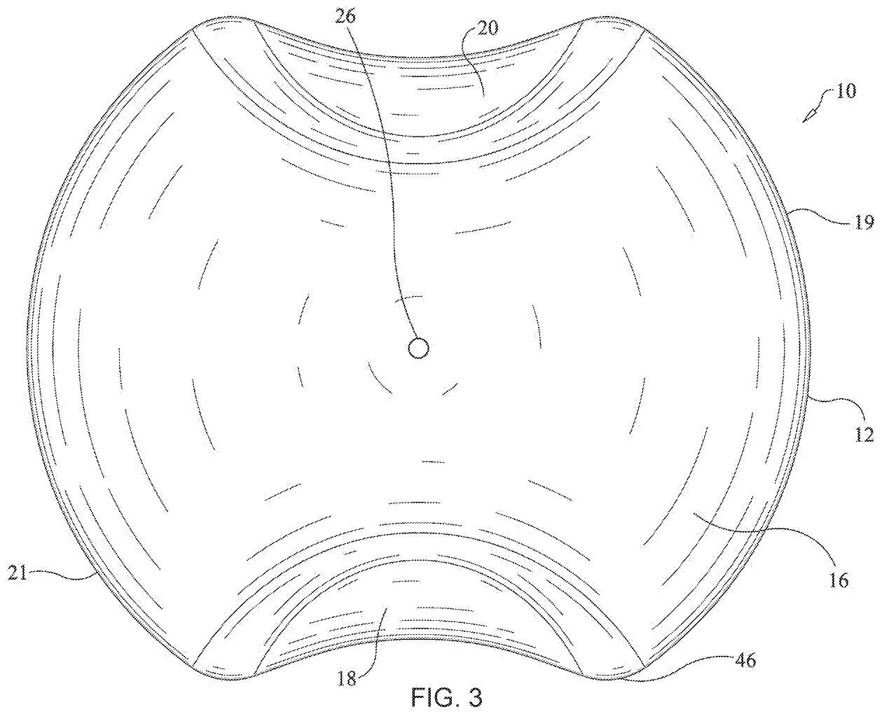

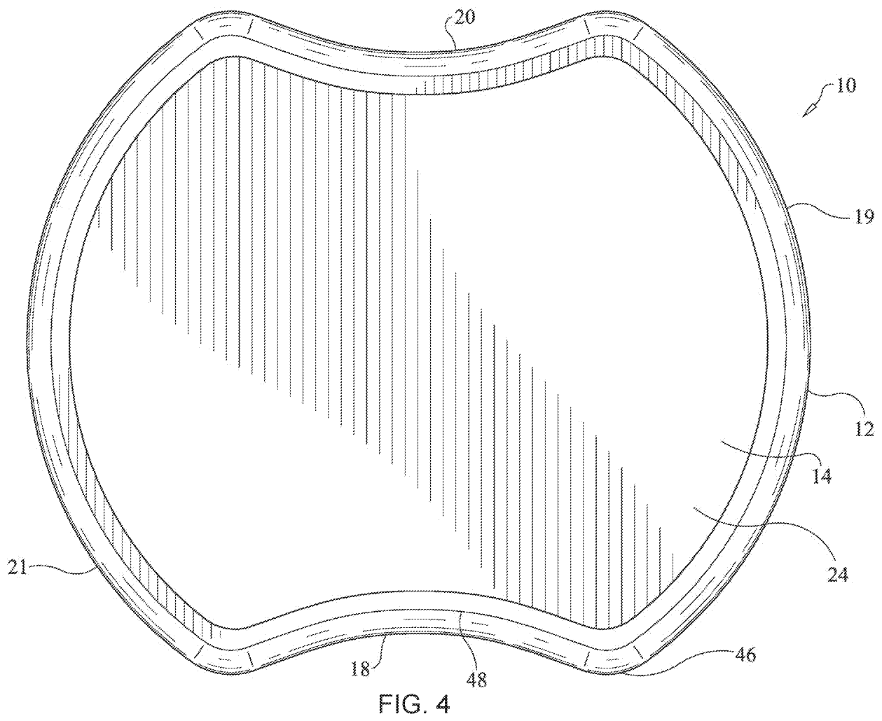

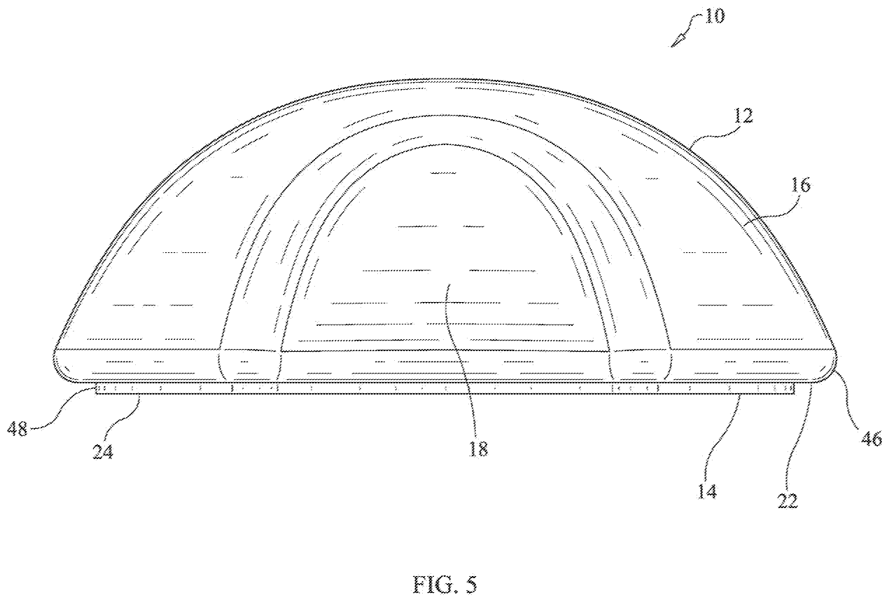

As discussed above, the body portion 12 can have a domed or curved shape with two inwardly extending arcuate side portions (i.e., a first inwardly arcuate side 18 and a second inwardly arcuate side 20). The two inwardly arcuate side portions 18 and 20 can be on opposites side relative to each other. Thus, as can be seen in the FIG. 3, the two arcuate side portions 18 and 20 curve inwardly toward the middle of the body portion 12. In one embodiment, the two arcuate side portions 18 and 20 curve inwardly such that the minimum width of the body portion 12 is approximately at the longitudinal center of the body portion 12. That is, the body portion has a first rounded end 19 that reaches a maximum width at one end of the two arcuate side portions 18 and 20, the two arcuate side portions 18 and 20 then curve inwardly to the minimum width. The two arcuate side portions 18 and 20 curve outwardly to the maximum width of the body portion at the second rounded end 21. This configuration forms an hourglass shape, as seen in FIG. 4. Moreover, since the body portion 12 has a domed configuration, the arcuate side portions 18 and 20 have a maximum width adjacent the bottom surface 22 of the body portion. The width of the arcuate side portions 18 and 20 decreases as the arcuate side portions 18 and 20 approach the apex of the curved top portion 16. Thus, as shown in FIG. 5, for example, the arcuate side portions 18 and 20 can form a parabolic shape. However, it is noted that the pet toy 10 can have any suitable number of arcuate side portions or portions including one (1) or more than two (2). The body portion 12 is preferably about 2.87 inches high, about 5.85 inches wide and about 7 inches long. However, the body portion 12 can have any suitable configuration or dimensions. For example, the body portion 12 can be smaller or larger depending on the intended pet size.

As shown in FIG. 7, the body portion 12 is generally hollow so as to define a hollow interior portion 34. Thus, the body portion 12 has an inner surface 36 defining the hollow interior portion 34 and an outer surface 38. The squeaker hole 26 passes from the inner surface 36 to the outer surface 38 and can include a groove 40, if desired. The width of the body portion is formed so as to be by flexible. That is, the body portion is configured so as to be compressible by a force applied by a pet. Such flexibility is a function of the width or the body portion relative to the material with which the body portion is formed. Preferably, the body portion is resistant to deformation such that a considerable force must be applied before deformation. In one embodiment, the width between the inner surface 36 to the outer surface 38 increases adjacent the bottom surface 22. Such an increase in width can improve the stability of the pet toy 10, and provide a thicker base to accommodate the groove 44, described in more detail below.

The bottom surface 22 is bounded on an inner side by the inner surface 36 and on an outer side by the outer surface 38. Thus, as can be understood, the bottom surface 22 defines an opening 42 in the bottom of the body portion 12. In one embodiment, the opening 42 has the same or a similar configuration to an outer perimeter 46 of the body portion 12. However, it is noted that the opening 42 can have any configuration desired. Further, is desired, it is not necessary to have an opening 42 and the bottom surface 22 of the body portion 12 can be continuous such that the interior portion 34 is completely enclosed.

The bottom surface 22 of the body portion 12 can include a slot or groove 44 that traverses the entire periphery of the body portion 12. As seen in FIG. 7, the groove 44 can be offset so as to be closer to the inner surface 36 of the body portion 12 than the outer surface 38. The groove 44 generally has a length that is greater than the width thereof

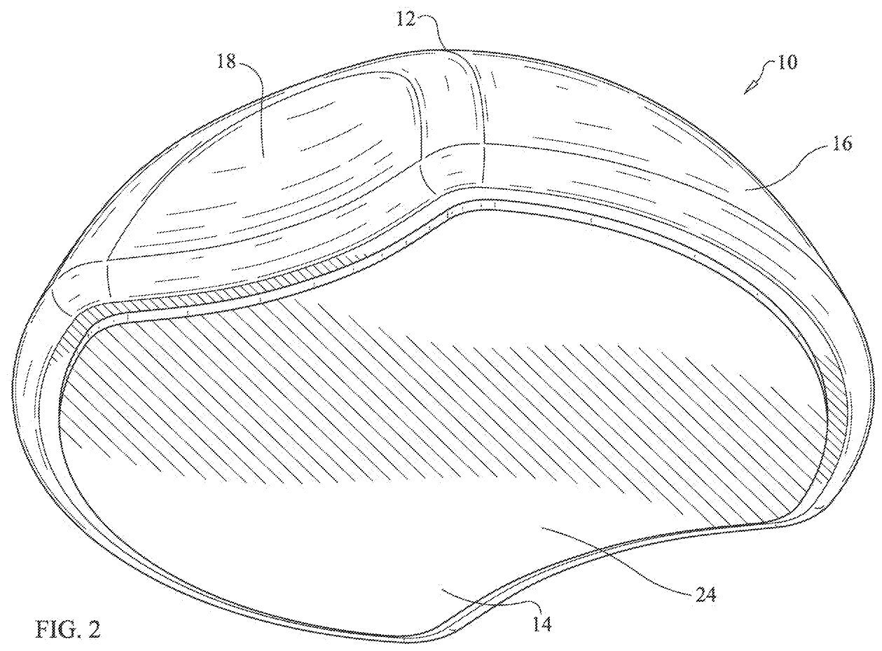

As shown in FIGS. 2 and 4-6, the sliding portion 14 is attached to a bottom surface 22 of the body portion 12 and is formed from polypropylene so as to have a reduced coefficient of friction with a surface on which the pet toy 10 is to slide. It is noted that the sliding portion 14 can be formed from any suitable material that would reduce the coefficient of friction between the floor and the toy.

The sliding portion 14 can have an outer perimeter 48 that has a shape or configuration that is generally similar to or the same as of the outer perimeter 46 of the body portion 12. Thus, the outer perimeter 48 of the sliding portion 14 can follow the contours of the outer perimeter 46 of the bottom surface 22 of the body portion 12. In particular, the sliding portion 14 can have a first inwardly extending arcuate side 50 and a second inwardly extending arcuate side 52. Further, the sliding portion 14 can have a first rounded end 54 and a second rounded end 56. However, in one embodiment, the area of the sliding portion 14 is similar to the area defined by the outer perimeter 48 of the body portion 12 but is a slightly smaller area.

As shown in FIGS. 7 and 8, the outer perimeter 48 of the sliding portion 14 can have an upward extending flange 58 that is configured to fit in and/or be disposed in the groove 44 in the bottom surface 22 of the body portion 12. The flange 58 can be removable disposed in the groove 44 with a friction fit, or the flange 58 can be fixed in the groove 44 with an adhesive or in any other suitable manner. In one embodiment, the flange 58 can have a width that is greater than the width of the groove 44. Thus, as can be understood, the groove 44 would fit into the groove 44 such that the sliding portion 14 is attached to the body portion 12 by a friction fit. Such a fit can be accomplished since the body portion 12 can be formed from a semi rigid or flexible material. In this embodiment, the sliding portion 14 can be removed and reattached to the body portion 12.

The upper surface 60 of the sliding portion 14 can have a supporting structure 62 that prevents the body portion 12 from deforming in such a manner as to contact the upper surface 60 of the sliding portion 14. Thus, the supporting structure 62 can prevent damage to the sliding portion 14 or the noise making device 28. In the illustrated embodiment, the supporting structure 62 is a hollow cylindrical sleeve that is positioned in such a manner that it can prevent the noise making device 28 from being damaged. In other words, when the body portion 12 is depressed, the noise making device 28 will be surrounded by the wall 64 of the supporting structure 62. The top 66 of the wall 64 will contact the interior surface 36 of the body portion 12, preventing the noise making device 28 from being compressed between the upper surface 60 of the sliding portion 14 and the interior surface 36 of the body portion and being damaged. While the illustrated embodiment shows the supporting structure 62 as a hollow cylindrical sleeve, it is noted that the supporting structure 62 can have any suitable configuration.

In one embodiment, to produce the pet toy 10, the body portion 12 is formed having the sliding (bottom) portion 14 and the curved top portion 16. The curved top portion 16 includes the arcuate side portions 18 and 20. The body portion 12 can be molded using rubber or any other semi rigid or flexible material. Preferably, the body portion 12 includes the opening 42 in the bottom surface 22, so that the mold does not include an undercuts, making removal of the body portion 12 from the mold a relatively easy process. However, the body portion 12 can be formed in multiple sections or in any other manner desired. For example, in one embodiment, the body portion 12 can be formed with upper and lower sections that are coupled together. Thus, the body portion 12 can be completely enclosed with no opening in the bottom thereof

The sliding portion 14 is formed from rigid plastic, such as polypropylene, so as to have a reduced coefficient of friction relative to a surface on which the pet toy 10 is to slide and is formed so as to be attachable to the body portion 12. The sliding portion 14 can be molded a single unitary member.

Prior to attaching the sliding portion to the body portion, the noise making device 28 can be attached to the body portion 12 with the neck portion 32 of the noise making device 28 being inserted into the squeaker opening 26. As can be understood, the neck portion 32 of the noise making device 28 can have a protrusion around the circumference thereof that can fit with in the groove 40 in the opening 26.

The flange 58 on the sliding portion 14 can then be inserted into the groove 44 in the bottom surface 22 of the body portion 12. The supporting structure 62 is configured and arranged such that the noise making device 28 is positioned within the inner area of the supporting structure 62.

In one embodiment, the flange 58 is sized and configured to frictionally fit within the groove 44, such that friction maintains the coupling between the body portion 12 and the sliding portion 14. However, as can be understood any other suitable manner of maintaining the attachment between the sliding portion 14 and the body portion 12 (adhesive, glue, heat molding, etc.) can be used.

The pet toy 10 can be positioned with the sliding portion 14 on a surface. As illustrated in FIG. 5, the sliding portion 14 extends slightly beyond the body portion 12. Thus, the body portion 12 is disposed away from the surface and preferably only the sliding portion 14 touches the surface. This configuration improves the slidability of the pet toy 10 and enables the body portion 12 to be formed from a different material than the sliding portion 14. In use, a pet will step on or put pressure on the body portion 12 of the pet toy 10. In one embodiment, the body portion 12 will flex or compress, which will in turn compress the noise making device 28. The noise making device will expel air through the neck portion 32 and out of the opening 26 causing a squeak or other desired noise. Additionally, the curved configuration of the body portion 12 and the reduced frictional coefficient between the surface and the sliding portion 14 will cause the pet toy to slide out from under the paw of the pet and slide across the surface. This, sliding and noise will intrigue the pet and cause the pet to chase after the pet toy and repeat the process.

The pet toy 10 described herein will increase the occupation of a pet's attention, while also improving the pets exercise, since the pet will chase the pet toy 10 through the indoor area of a home or house or other indoor structure. Further, the pet toy 10 will improve the occupation of a pet's attention without the need for additional food or treats.

### General Interpretation of Terms

In understanding the scope of the present invention, the term “comprising” and its derivatives, as used herein, are intended to be open ended terms that specify the presence of the stated features, elements, components and/or groups, but do not exclude the presence of other unstated features, elements, components and/or groups. The foregoing also applies to words having similar meanings such as the terms, “including”, “having” and their derivatives. Also, terms, such “section” and “portion”, when used in the singular can have the dual meaning of a single part or a plurality of parts. The term “configured” as used herein to describe a component, section or part of a device that is constructed to carry out the desired function.

The terms of degree such as “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A pet toy comprising:
a curved body portion having a substantially hollow interior;
a bottom portion coupled to the curved body portion, the bottom portion having:
a substantially planar lower surface;
an upper surface substantially opposite the lower surface; and
a wall extending from the upper surface; and
a noise making device coupled to the upper surface, the noise making device having a lower portion and an upper portion, the lower portion being coupled to the upper portion;
wherein the bottom portion is coupled to the curved body portion so that the wall is received within the substantially hollow interior of the curved body portion, the curved body portion is adapted to be compressed relative to at least a portion of the noise making device and the wall of the bottom portion, and the noise making device is configured to emit a noise when sufficiently compressed between the curved body portion and the wall.

2. The pet toy of claim 1, wherein the curved body portion includes a pair of inwardly extending arcuate side portions on opposite sides of the curved body portion.

3. The pet toy of claim 1, wherein the curved body portion includes an inwardly extending arcuate portion, the arcuate portion having a crescent shape as viewed from above.

4. The pet toy of claim 1, wherein the lower surface of the bottom portion is formed from a rigid plastic having a coefficient of friction that is less than a coefficient of friction of a surface to permit the lower surface to slide along the surface.

5. The pet toy of claim 1, wherein the curved body portion includes an opening positioned proximate an apex of the curved body portion and the upper portion of the noise making device extends from the lower portion of the noise making device and toward the opening.

6. The pet toy of claim 1, wherein:
the bottom portion includes a support member; and
the curved body portion defines a groove extending around a periphery of the curved body portion, the groove configured to receive the support member.

7. The pet toy of claim 6, wherein the groove is closer to an inner surface of the curved body portion than an outer surface of the curved body portion.

8. The pet toy of claim 6, wherein the support member defines a first width and the groove defines a second width, and the first width is greater than the second width.

9. The pet toy of claim 1, wherein the curved body portion is formed from a flexible material to allow the curved body portion to compress the noise making device to emit the noise through an opening in the curved body portion.

10. The pet toy of claim 1, wherein the curved body portion has an inner surface defining the substantially hollow interior and an outer surface opposite the inner surface, and a width of the curved body portion between the inner surface and the outer surface is greater near the substantially planar lower surface than the curved body portion.

11. The pet toy of claim 1, wherein the curved body portion includes a flexible material to allow the curved body portion to be depressed toward the bottom portion, depression of the curved body portion toward the bottom portion is configured to compress the noise making device between the curved body portion and the bottom portion to cause the noise making device to emit the noise toward an opening in the curved body portion.

12. A pet toy comprising:
a curved body portion having a substantially hollow interior and an opening provided therein;
a bottom portion coupled to the curved body portion, the bottom portion having:
a substantially planar lower surface; and
an upper surface substantially opposite the lower surface; and
an air-operated noise making device coupled to the upper surface, the noise making device having a lower portion and an upper portion, the lower portion coupled to the upper portion;
wherein the noise making device is coupled to the bottom portion so that the noise making device is received in the substantially hollow interior and the noise making device is adapted to be compressed and configured to emit a noise toward the opening when sufficiently compressed.

13. The pet toy of claim 12, wherein the opening is positioned at an apex of the curved body portion, the upper portion of the noise making device exposed through the opening.

14. The pet toy of claim 12, wherein the bottom portion includes a cylindrically shaped wall extending from the upper surface of the bottom portion toward the curved body portion.

15. A method of producing a pet toy, the method comprising:
providing a curved body portion having a substantially hollow interior;
providing a bottom portion having:
a lower surface;
an upper surface substantially opposite the lower surface; and
a wall extending from the upper surface;
inserting a noise making device into the wall of the bottom portion, the noise making device including a lower portion and an upper portion, the lower portion being coupled to the upper portion; and
coupling the bottom portion to the curved body portion such that the lower portion of the noise making device is positioned within the substantially hollow interior.

16. The method of claim 15, wherein the curved body portion includes flexible material to permit the curved body portion to be depressed.

17. The method of claim 15, wherein the bottom portion includes a support member extending from the upper surface.

18. The method of claim 15, wherein the lower surface has a polymeric material with a coefficient of friction that is less than a coefficient of friction of a surface to permit the bottom portion to slide along the surface.

19. The method of claim 16, wherein an opening in the curved body portion is positioned proximate an apex of the curved body portion, the upper portion of the noise making device at least partially exposed through the opening.

20. The method of claim 16, wherein the wall extends from the upper surface of the bottom portion toward an opening in the curved body portion.
